(19) United States
(12) Patent Application Publication
(10) Pub. No.: US 2013/0317896 A1
(43) Pub. Date: Nov. 28, 2013

(54) INTERNET PRICE MATCHING USING A MOBILE WALLET

(71) Applicant: Michael A. Liberty, Windermere, FL (US)

(72) Inventor: Michael A. Liberty, Windermere, FL (US)

(21) Appl. No.: 13/901,932

(22) Filed: May 24, 2013

Related U.S. Application Data
(60) Provisional application No. 61/652,065, filed on May 25, 2012.

(51) Int. Cl. G06Q 30/02

(52) U.S. Cl. CPC G06Q 30/0222
USPC 705/14.23

(57) ABSTRACT

Embodiments are directed to receiving reimbursement from a product vendor for a price-matched item and to providing a retailer with the lowest online price for price matching. In one scenario, a user may use a mobile wallet to pay for an item at a retail goods store. The retailer may be one that offers price matching. The user may perform an online search to determine that the item is priced lower at various online vendors. The user can then purchase the item at the retailer for the lower, price-matched price (i.e. the price offered by the online vendor). If the retailer has an agreement in place with the product's manufacturer that the retailer will provide the lowest price, the retailer may be able to receive reimbursement from the online vendor for the difference in price between the retailer's price and the online vendor's price.

### CROSS-REFERENCE TO RELATED APPLICATIONS

This application claims priority to and the benefit of U.S. Provisional Application Ser. No. 61/652,065, entitled “Internet Price Matching Using a Mobile Wallet”, filed on May 25, 2012, which application is incorporated by reference herein in its entirety.

### BACKGROUND

Computers have become highly integrated in the workforce, in the home, in mobile devices, and many other places. Computers can process massive amounts of information quickly and efficiently. Software applications designed to run on computer systems allow users to perform a wide variety of functions including business applications, schoolwork, entertainment and more. Software applications are often designed to perform specific tasks, such as word processor applications for drafting documents, or email programs for sending, receiving and organizing email.

Today's smart phones use software applications to perform a wide variety of functionality. In some cases, this functionality may include the ability to pay for items using a mobile payment system. Such a mobile payment system may allow users to pay for items at a store or over the internet using their phone.

### BRIEF SUMMARY

Embodiments described herein are directed to receiving reimbursement from a product vendor for a price-matched item and to providing a retailer with the lowest online price for price matching. In one embodiment, a user may use a mobile wallet to pay for an item at a retail goods store. The retailer may be one that offers price matching. As such, if the user finds a lower price at another store, or in an advertisement for another store, the user can purchase the item at the retailer for the lower, price-matched price. In some cases, retailers also price match prices found on the internet. Thus, in some embodiments, the user can use the mobile wallet application to find lower prices online and present those prices to the retailer. In some cases, the retailer may have an agreement in place with the product's manufacturer that the retailer will provide the lowest price. Thus, if another vendor (e.g. an online vendor) is providing a lower price, the retailer may be able to receive reimbursement from the online vendor for the difference in price between the retailer's price and the online vendor's price.

Thus, in some embodiments, a user may be able to scan an item's bar code and perform a search online to discover a lower price. This functionality may be provided by the mobile wallet. If the search discovers a price lower than that provided by the retail goods store in which the user is presently located, the price and the online vendor's information (such as website, location, etc.) may be stored in the mobile wallet. When the user checks out using the mobile wallet, the mobile wallet may present the lower price automatically. This price may be verified by the retailer's electronic payment system. Once verified, the lower price may be given for the user and the user may purchase the item at the lower (online price-matched) price using his or her mobile wallet. The retailer's electronic payment system may then submit a request to the online vendor for the price difference between the retailer's price and the online vendor's price. As such, the user may purchase items at the lowest possible cost, while the retailer can get reimbursed from online vendors that are attempting to undersell the retailer.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages will be set forth in the description which follows, and in part will be apparent to one of ordinary skill in the art from the description, or may be learned by the practice of the teachings herein. Features and advantages of embodiments described herein may be realized and obtained by means of the instruments and combinations particularly pointed out in the appended claims. Features of the embodiments described herein will become more fully apparent from the following description and appended claims.

### BRIEF DESCRIPTION OF THE DRAWINGS

To further clarify the above and other features of the embodiments described herein, a more particular description will be rendered by reference to the appended drawings. It is appreciated that these drawings depict only examples of the embodiments described herein and are therefore not to be considered limiting of its scope. The embodiments will be described and explained with additional specificity and detail through the use of the accompanying drawings in which:

FIG. 1 illustrates a computer architecture in which embodiments described herein may operate.

FIG. 2 illustrates a computer architecture in which reimbursements may be received from a product vendor for price-matched items.

FIG. 3 illustrates an embodiment of a mobile wallet application running on a mobile device.

FIG. 4 illustrates a flowchart of an example method for receiving reimbursement from a product vendor for a price-matched item.

FIG. 5 illustrates a flowchart of an example method for providing a retailer with the lowest online price for price matching.

### DETAILED DESCRIPTION

Embodiments described herein extend to methods, systems, and computer program products for receiving reimbursement from a product vendor for a price-matched item. Embodiments also include providing a retailer with the lowest online price for price matching. As such, a user can purchase an item in the retailer's store for an online price-matched price.

In some embodiments, a user has an account with a mobile payment system. The mobile payment system can provide the user with a variety of functionality including purchasing items along with one or more of depositing funds, withdrawing funds, transferring funds, etc. Accordingly, the user can use a digital device (e.g., a computer or mobile phone) to interact with the electronic payment system to pay for goods and/or services. This mobile payment system may be referred to herein as a “mobile wallet” or “mobile wallet application”.

For example, a user may use a mobile wallet to pay for an item at a retail goods store. The retailer may be one that offers price matching. As such, if the user finds a lower price at another store, or in an advertisement for another store, the user can purchase the item at the retailer for the lower, price-matched price. In some cases, retailers also price match prices found on the internet. Thus, in some embodiments, the user can use the mobile wallet application to find lower prices online and present those prices to the retailer. In some cases, the retailer may have an agreement in place with the product's manufacturer that the retailer will provide the lowest price. Thus, if another vendor (e.g. an online vendor) is providing a lower price, the retailer may be able to receive reimbursement from the online vendor for the difference in price between the retailer's price and the online vendor's price.

Thus, in some embodiments, a user may be able to scan an item's bar code and perform a search online to discover a lower price. This functionality may be provided by the mobile wallet. If the search discovers a price lower than that provided by the retail goods store in which the user is presently located, the price and the online vendor's information (such as website, location, etc.) may be stored in the mobile wallet. When the user checks out using the mobile wallet, the mobile wallet may present the lower price automatically. This price may be verified by the retailer's electronic payment system. Once verified, the lower price may be given for the user and the user may purchase the item at the lower (online price-matched) price using his or her mobile wallet. The retailer's electronic payment system may then submit a request to the online vendor for the price difference between the retailer's price and the online vendor's price. As such, the user may purchase items at the lowest possible cost, while the retailer can get reimbursed from online vendors that are attempting to undersell the retailer.

In some embodiments, a client application for the electronic payment system (e.g. the mobile wallet) runs on the user's digital device. The user interacts with the electronic payment system through the client application. From a screen of the client application, the user can perform the bar code scanning and online price searching. The client application may be any type of software application configured to run on a mobile device. In some cases, the client application may be a mobile wallet application. In other cases, the client application may be a shopping application that allows a user to shop for items on an internet retailer. Substantially any kind of shopping application or other type of client application may be used with and may interact with the electronic payment system. The client application may be used to perform price checking, as will be described further below.

Embodiments of the invention include mobile telephones, tablets or other digital devices interoperating with an electronic payment system, such as, for example, a mobile wallet, to purchase goods and/or services.

Embodiments of the present invention may comprise or utilize a special purpose or general-purpose computer including computer hardware, such as, for example, one or more processors and system memory, as discussed in greater detail below. Embodiments within the scope of the present invention also include physical and other computer-readable media for carrying or storing computer-executable instructions and/or data structures. Such computer-readable media can be any available media that can be accessed by a general purpose or special purpose computer system. Computer-readable media that store computer-executable instructions are computer storage media (devices). Computer-readable media that carry computer-executable instructions are transmission media. Thus, by way of example, and not limitation, embodiments of the invention can comprise at least two distinctly different kinds of computer-readable media: computer storage media (devices) and transmission media.

Computer storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry or desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to computer storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. Thus, it should be understood that computer storage media (devices) can be included in computer system components that also (or even primarily) utilize transmission media.

Computer-executable instructions comprise, for example, instructions and data which, when executed at a processor, cause a general purpose computer, special purpose computer, special purpose processing device, to perform a certain function or group of functions. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the invention may be practiced in network computing environments with many types of computer system configurations, including, personal computers, desktop computers, laptop computers, message processors, hand-held devices, single- or multi-processor systems having hardware processors, microprocessor-based or programmable consumer electronics, network PCs, minicomputers, mainframe computers, mobile telephones (having various different capabilities and features), PDAs, pagers, routers, switches, and the like. Embodiments of the invention may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

An electronic payment system architecture can include a plurality of independent components that each contribute to the functionality of the system as a whole. This modularity allows for increased flexibility when approaching issues of platform scalability and, to this end, provides a variety of advantages. System complexity and growth can be managed more easily through the use of smaller-scale parts with limited functional scope. Platform fault tolerance is enhanced through the use of these loosely coupled modules. Individual components can be grown incrementally as business needs dictate. Modular development also translates to decreased time to market for new functionality. New functionality can be added or subtracted without impacting the core system.

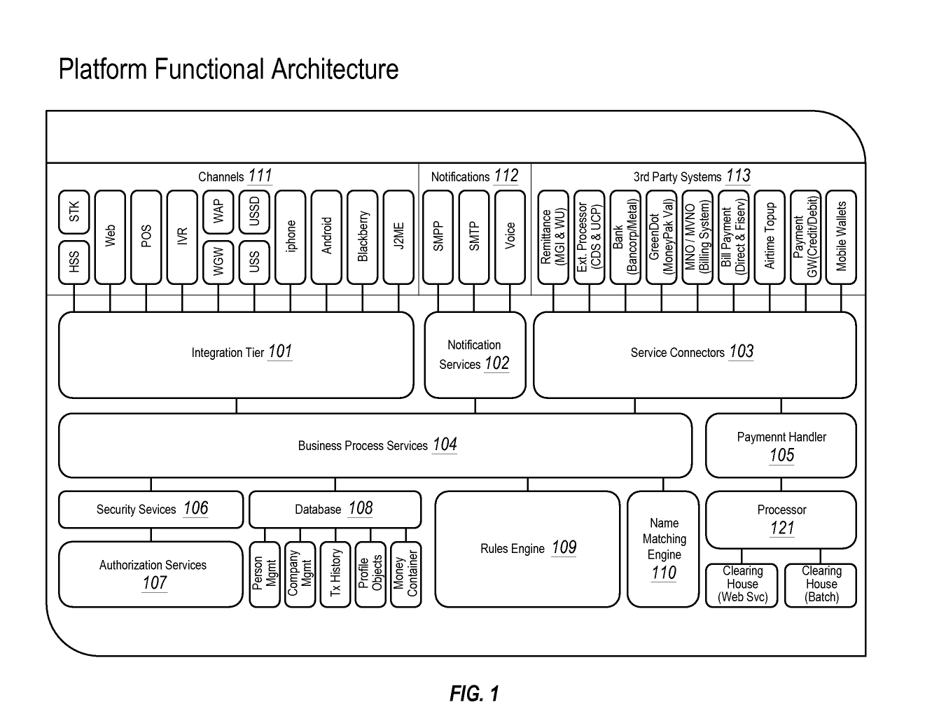

FIG. 1 illustrates an example system architecture for an electronic payment system. Integration tier 101 is configured to manage sessions and maintain integrity of financial transactions. Integration tier 101 can also include a communication (e.g., Web services) API and/or other communication mechanisms to accept messages from channels 111. Other mechanisms include, but are not limited to: International Standards Organization (“ISO”) 8583 for Point of Sale (“POS”) and Automated Teller Machines (“ATM”) devices and Advanced Message Queuing Protocol (“AMQP”) for queue based interfaces. Each of channels 111 can be integrated to one or more mechanisms for sending messages to integration tier 101. Notification services 102 is configured to send various notifications through different notification channels 112, such as, for example, Short Message Peer-to-Peer (“SSMP”) for Short Messaging Service (“SMS”) and Simple Mail Transfer Protocol (“SMTP”) for emails. Notification services 102 can be configured through a Web services API.

Service connectors 103 are a set of connectors configured to connect to 3rd party systems 113. Each connector can be a separate module intended to integrate an external service to the system architecture. Business process services 104 are configured to implement business workflows, including executing financial transactions, auditing financial transactions, invoking third-party services, handling errors, and logging platform objects. Payment handler 105 is configured to wrap APIs of different payment processors, such as, for example, banking accounts, credit/debit cards or processor 121. Payment handler 105 exposes a common API to facilitate interactions with payment processors. Security services 106 are configured to perform client authentication. Authorization services 107 are configured to perform client authorization, such as, for example, using a database-based Access Control List (“ACL”) table.

Database 108 is configured to manage customer accounts (e.g., storing customer accounts and properties), manage company accounts (e.g., storing company accounts and properties), manage transaction histories (e.g., storing financial transaction details), store customer profiles, store dictionaries used by the electronic payment system, such as, for example, countries, currencies, etc., and manage money containers. Rules engine 109 is configure to gather financial transaction statistics and uses the statistics to provide transaction properties, such as, for example, fees and bonuses. Rules engine 109 is also configured to enforce business constraints, such as, for example, transactions and platform license constraints.

Name matching engine 110 is configured to match different objects according to specified configuration rules. Matching engine 110 can be use to find similarities between names, addresses, etc. Processor 121 is configured to manage financial accounts and transactions. Processor 121 can be used to hold, load, withdraw and deposit monetary rewards to mobile wallet accounts. Processor 121 can also be used as a common interface to a third party processor system. When used as a common interface, financial operations are delegated to the external processor. A Clearing House subsystem of processor 121 can be used to exchange the financial information with a bank.

Components of a electronic payment system can be connected to one another over (or be part of) a system bus and/or a network. Networks can include a Local Area Network (“LAN”), a Wide Area Network (“WAN”), and even the Internet. Accordingly, components of the electronic payment system can be “in the cloud”. As such, electronic payment system components as well as any other connected computer systems and their components, can create message related data and exchange message related data (e.g., Internet Protocol (“IP”) datagrams and other higher layer protocols that utilize IP datagrams, such as, Transmission Control Protocol (“TCP”), Hypertext Transfer Protocol (“HTTP”), Simple Mail Transfer Protocol (“SMTP”), etc.) over the system bus and/or network.

In this description and the following claims, “cloud computing” is defined as a model for enabling on-demand network access to a shared pool of configurable computing resources (e.g., networks, servers, storage, applications, and services). The definition of “cloud computing” is not limited to any of the other numerous advantages that can be obtained from such a model when properly deployed.

For instance, cloud computing is currently employed in the marketplace so as to offer ubiquitous and convenient on-demand access to the shared pool of configurable computing resources. Furthermore, the shared pool of configurable computing resources can be rapidly provisioned via virtualization and released with low management effort or service provider interaction, and then scaled accordingly.

A cloud computing model can be composed of various characteristics such as on-demand self-service, broad network access, resource pooling, rapid elasticity, measured service, and so forth. A cloud computing model may also come in the form of various service models such as, for example, Software as a Service (“SaaS”), Platform as a Service (“PaaS”), and Infrastructure as a Service (“IaaS”). The cloud computing model may also be deployed using different deployment models such as private cloud, community cloud, public cloud, hybrid cloud, and so forth. In this description and in the claims, a “cloud computing environment” is an environment in which cloud computing is employed.

The components depicted in FIG. 1 can interoperate to provide a number of financial and other services including but not limited to enrolling a customer for a mobile wallet, adding a stored value account (either hosted by an electronic payment system or a third party), adding a bank/credit union account to a mobile wallet, adding a debit/credit card account to a mobile wallet, depositing monetary rewards in a mobile wallet, withdrawing funds from a mobile wallet, paying bills from a mobile wallet, topping up a prepaid mobile account through a mobile wallet, transferring funds through a mobile wallet, and making in-store purchases from a mobile wallet.

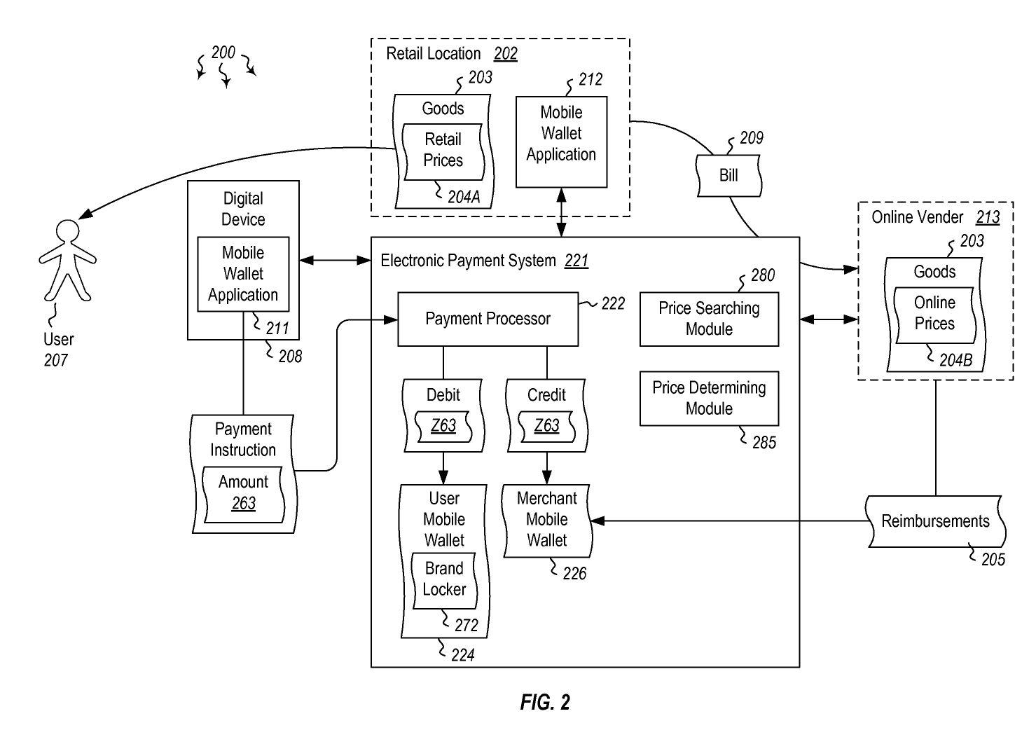

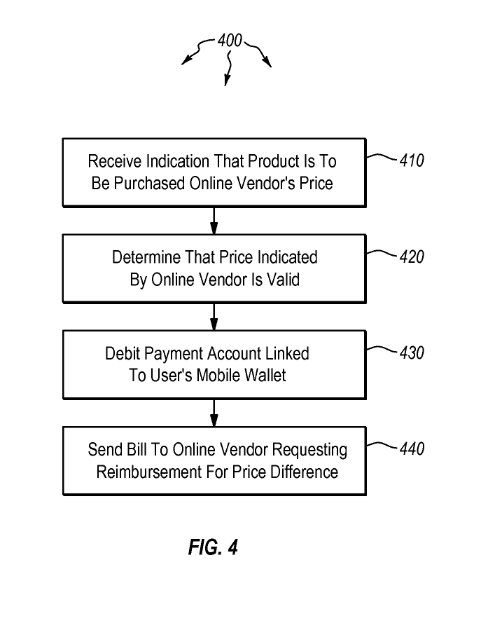

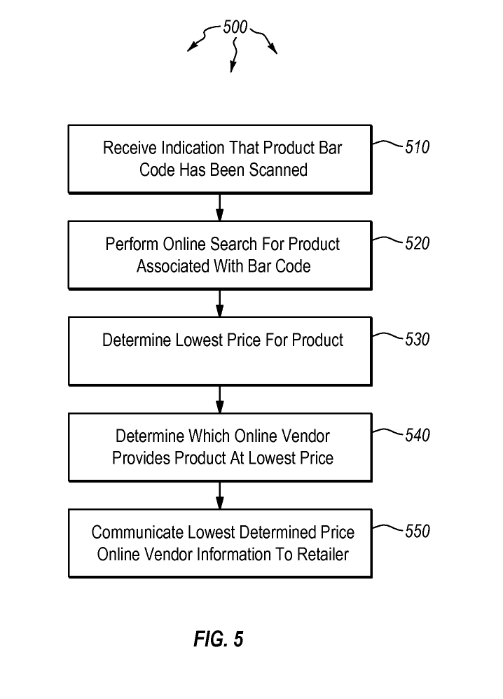

FIG. 2 depicts a computer system architecture 200 for providing a retailer with the lowest online price for price matching and for receiving reimbursement from a product vendor for a price-matched item. Figure 2 will be described in conjunction with the methods 400 and 500 of FIGS. 4 and 5 below.

As depicted in FIG. 2, computer architecture 200 includes digital device 208, retail location 202, and electronic payment system 221. Digital device 208 further includes mobile wallet application 211. Retail location 202 further includes its own mobile wallet application 211. Electronic payment system 221 further includes payment processor 222, user mobile wallet 224 (user 207's mobile wallet), merchant mobile wallet 226 (retail location 202's mobile wallet), price searching module 280 and price determining module 285.

FIG. 2 depicts three different parties: an end user (207), a retailer 202 and an online vendor 213. The end user may be shopper shopping for goods 203 at the retailer's store. The online vendor may be a merchant that sells goods online. In some cases, the online vendor may sell some of the same goods that the retailer sells. Still further, in some cases, the retailer's prices on goods (i.e. retail price 204A) may be different than the online vendor's price (i.e. online price 204B). The retailer may have an agreement in place with other vendors and/or with producers of goods to sell the goods at the lowest possible price. If another vendor sells those goods for a lower price, the retailer may be entitled to some form of reimbursement from the vendor. Thus, at least in some embodiments, if online price 204B is lower than retail price 204A for a particular good, the retailer may receive reimbursement 205 for the price difference.

Each entity (the user, the retailer and the online vendor) is connected to electronic payment system 221. The electronic payment system 221 may be thought of as a portal that facilitates the transfer of data between each of the entities. For example, the electronic payment system 221 may act as a portal to receive product information, facilitate an internet search for the lowest online price, and then communicate that price back to the user. In some cases, the number of online vendors (e.g. 213) may be limited to ensure that fraudulent activity is avoided. Indeed, each online vendor may be vetted by the electronic payment system, or may be authenticated or otherwise verified to ensure that the online price is legitimate.

As such, the electronic payment system 221 may receive from a user an indication that a product sold by the retailer is to be purchased for a price indicated by an online vendor, where the user has a mobile wallet with one or more linked payment accounts (act 410). The electronic payment system then determines that the price indicated by the online vendor is valid for the product (act 420), debits at least one of the payment accounts linked to the user's mobile wallet for the price indicated by the online vendor (act 430), and sends a bill to the online vendor to request reimbursement for the difference in price between the retailer's price and the online vendor's price (act 440).

Each entity may have their own mobile wallet, or may have other access to the electronic payment system. For instance, as explained above, many different types of client applications including shopping applications and other similar applications may allow the user to access the electronic payment system. Indeed, substantially any application that allows the user to purchase goods or services over the internet may be configured for use with the electronic payment system, and may be further configured to perform price checking using the modules and systems described herein. The user may use the mobile wallet 224 to pay for the retailer's goods 203. The retailer's mobile wallet 226 may be provided by a mobile wallet application 212. The retailer's mobile wallet allows users to pay for the retailer's goods using their own mobile wallets. The online vendor may similarly have its own mobile wallet or other means of allowing users to pay for goods using their mobile wallets via the electronic payment system 221.

When the user is shopping for goods in the retailer's store 202, the user may use their digital device 208 to scan a bar code of a particular item. The mobile wallet application 211 (or other client application) or the price searching module 280 of the electronic payment system 221 can then search online for the item associated with that bar code. The search may provide a variety of results, and the price determining module 285 may determine which is the lowest price and which vendor provides that price. This data may be stored in the mobile wallet and/or electronic payment system memory. When the user goes to check out and pay for their goods, the online price 204B may be provided to the retailer for that good. If the retailer provides price matching, the user will simply pay for the item at the online price using their mobile wallet. As such, the online price-matching is applied automatically by the user's mobile wallet and is accepted by the retailer's mobile wallet or electronic payment system.

In one embodiment, as described in method 500 of FIG. 5, a computer system (e.g. the electronic payment system 211) receives an indication that a bar code has been scanned for a specified product (act 510). The computer system performs an online search for the product associated with the bar code (act 520). The online search is configured to provide pricing information for the product and its corresponding online vendors. The computer system determines, from the results of the online search, the lowest price for the product (act 530), determines, from the results of the online search, which online vendor provides the product at the determined lowest price (act 540), and communicates the lowest determined price and corresponding online vendor information to the retailer for price matching the indicated product (550). In this manner, a retailer can be reimbursed by a goods producer after price-matching a customer in one of their retail locations.

Then, due to the retailer's agreement with other vendors or product manufacturers, the retailer may send a bill 209 via the electronic payment system 221 to the online vendor 213. The bill may request reimbursement for the difference in price between the retail price 204A (e.g. the minimum agreed-upon price between the retailer and the product manufacturer or other vendors) and the online price 204B. In some cases, the difference in prices may be reduced to account for shipping costs that the online retailer would have added to the online price 204B.

Additionally or alternatively, the retail location may have an agreement with various goods producers that the goods producers will provide an account (e.g. a “coupon account”) with money or credits which can be accessed by the retailer when a customer uses a coupon or otherwise applies a price discount. The money or credits in this account are then transferred automatically to the retailer when the user pays for an item using the online price. The amount of money or credits transferred is equal to the difference in price between the retailer's price and the online price. The money or credits may be transferred from the coupon account instantaneously each time an online price-matched transaction occurs, or may occur at some periodic interval (e.g. hourly or daily) in a batch of such transactions. Accordingly, after the user has paid for an item from a specified goods producer, the money or credits in that producer's coupon account are withdrawn automatically (either instantaneously or in batch) to cover the difference in price.

In some cases, an online vendor may be selling a product, and the retailer may have no price-matching agreement with that vendor. In such cases, it still may be possible to receive reimbursement from the goods producer directly. For instance, a user may purchase a product at the retailer's store, and pay the price-matched, online vendor's price (perhaps less shipping costs). The retailer may then be able to contact the manufacturer or producer of the goods and receive the difference in price from them as a reimbursement. In still other cases, the retailer may be reimbursed by both the online vendor and the producer. For instance, the online vendor may reimburse the retailer for at least part of the difference in price, and the product producer may reimburse the retailer for the remainder of the price difference.

When paying for goods 203, mobile wallet application 211 (or another client application) can send payment instruction 243 in amount 263 to electronic payment system 221. Payment processor 222 can receive payment instruction 243. In response, payment processor 222 can debit 241 user mobile wallet 224 by amount 263. Payment processor 222 can also credit 242 merchant mobile wallet 226 by amount 263. Moreover, when the user purchases an item at an online price-matched price, information regarding that user (e.g. information about past purchases, personal information including demographic information, etc.) may be sent to the electronic payment system 221 and, at least in some cases, to the retail location 202 and/or to the goods producer.

User 207 can use mobile wallet application 211 to participate in opt-in advertising. For example, user 207 can use mobile wallet application 211 to send opt-in 244 to electronic payment system 221. Advertising module 233 can receive opt-in 244 and record that mobile wallet application 211 has opted in for advertising. As such, when user 207 makes a purchase using mobile wallet application 211, a list of purchased items is sent to electronic payment system 221. For example, upon purchasing goods 203, an item list may be sent to electronic payment system 221 and stored in electronic processing system memory.

In some cases, when a user buys certain goods repeatedly, the user may gain loyalty points with that retailer. These loyalty points or other rewards may be stored in the brand locker 272 of the user's mobile wallet. These points, coupons or other rewards may be applied automatically when a user uses their mobile wallet to purchase these goods. The loyalty reward can be provided directly by the manufacturer of goods, or by the provider of the mobile wallet application 211. Electronic payment system 221 can notify a user when a loyalty reward has been transferred to their mobile wallet. For example, electronic payment system 221 can send a loyalty reward notification to mobile wallet application 211 to indicate that monetary reward 277 has been stored in brand locker 272.

Accordingly, embodiments of the invention permit user 207 find the lowest price for an item online and pay for that item in a store using the online price. The retailer can then request reimbursement from the online vendor that provided the lower, online price. The price search, price matching and reimbursing can all be accomplished using the electronic payment system 221 and/or with each party's respective mobile wallets.

Although not depicted, various other modules from the architecture of FIG. 1 can also be included electronic payment system 221. The modules expressly depicted in FIG. 2 can interoperate with these other modules as appropriate to facilitate desired functionality.

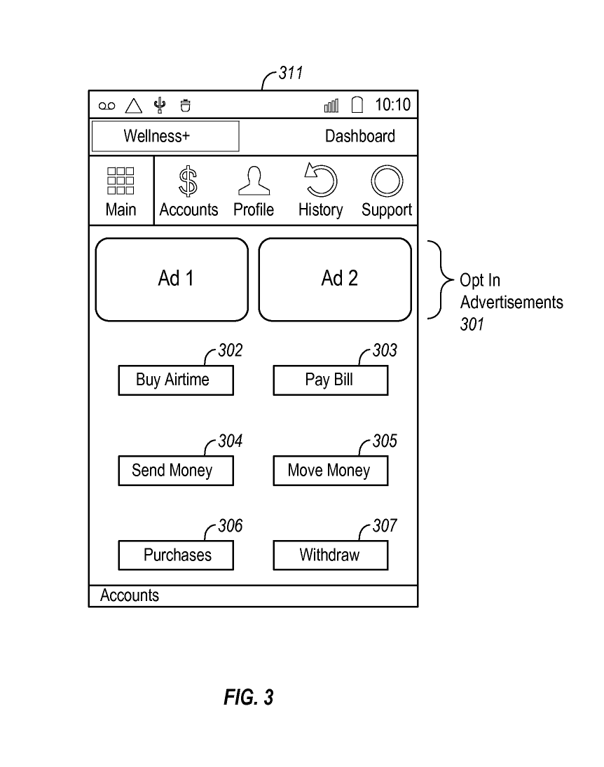

FIG. 3 depicts a screen shot of a mobile wallet client application 311 (e.g., similar to or the same as mobile wallet application 211). As depicted, advertisements 301 may be presented within the user-interface for mobile wallet client application 311. These advertisements may be opt-in (in which case the user may receive rewards for opting in), or may be provided as a way to make the mobile wallet application free to use or at a reduced cost. A user can interact with advertisements 301 when desired, and can receive coupons or other rewards from an electronic payment system (e.g. 221) as a result. As shown on the other virtual buttons, users may buy airtime (302), send money (304), move money (305), pay bills (303), withdraw money (307) or opt in to advertising to receive rewards. Various other buttons may be provided by the mobile wallet application 211 including a button that provides the ability to make purchases (306), the ability to scan bar codes or provide other functionality that is implemented in conjunction with internet price matching. Accordingly, those buttons shown in Figure 3 are merely examples of buttons and functionality that may be provided by the mobile wallet application.

The functionality of the mobile wallet may be provided to a user regardless of whether the user has a bank account. The use may save up monetary rewards which are sent to the user's brand locker or other monetary store within the user's mobile wallet. These rewards may be spent or otherwise used without the user having a bank account, credit union account or other type of account with a financial entity. Moreover, the mobile wallet may be used and monetary rewards may be sent to users that have prepaid phones or pay-as-you-go phone plans. Accordingly, a user may use the mobile wallet and/or the monetary rewards system with a prepaid (or other) phone and without a bank account. The mobile wallet may be used with any type of currency, and any stored rewards may be adjusted for value based on current location of the user. The monetary rewards may be paid to the user on substantially any provider-defined or user-defined basis. The monetary rewards may include money, store-specific money (usable only at that store), brand-specific money (usable to buy goods of that brand) or other forms of currency including token-based currencies.

Embodiments of the invention can adhere to Know Your Customer (KYC) rules in the US by performing Customer Identification Program (CIP) checks as required by the Bank Secrecy Act and US PATRIOT Act. A minimum amount of information can be gathered about a customer, such as, for example, First Name, Last Name, Date of Birth, Government ID Type, Government ID Number, Address. The CIP processes are designed to validate customer identity against government blacklists and assists in the prevention of money laundering and terrorist financing. A combination of non-documentary and documentary verification can be used to ensure beyond a reasonable doubt the identity of the customer.

Non-Documentary Verification can occur through the presentment of the information that was collected from the user to an external third party, such as, for example, Lexis Nexis. Documentary Verification can occur if non-documentary verification fails, then the user is asked to present an unexpired government ID. Various differ forms of identification including Driver's license, Passport, Alien identification (e.g., green card or work visa), and Mexican Consular identification card, can be accepted.

Embodiments of the invention can perform Anti-Money Laundering (AML) and Combating the Financing of Terrorism (CFT) checks. AML and CFT checks can be performed using transaction monitoring methods to flag names and suspicious transactions for further investigation. The electronic payment system can perform AML and CFT checks on all electronic financial transactions to ensure that electronic funds are not being used for money laundering or terrorism. Transaction limits can be placed on user accounts. The transaction limits are fully configurable for each particular use case, channel and payment method that allows maximum flexibility to restrict higher risk use cases. Velocity checks can also be performed. Velocity Checks ensure that subscribers are not abusing the electronic payment system within the allowable limits.

Embodiments described herein may be implemented in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

I claim:

1. A computer system comprising the following:
one or more processors;
system memory;
one or more computer-readable storage media having stored thereon computer-executable instructions that, when executed by the one or more processors, causes the computing system to perform a method for receiving reimbursement from a product vendor for a price-matched item, the method comprising the following:
an act of receiving from a user an indication that a product sold by the retailer is to be purchased for a price indicated by an online vendor, the user having a mobile wallet with one or more linked payment accounts;
an act of determining that the price indicated by the online vendor is valid for the product;
an act of debiting at least one of the payment accounts linked to the user's mobile wallet for the price indicated by the online vendor; and
an act of sending a bill to the online vendor to request reimbursement for the difference in price between the retailer's price and the online vendor's price.

2. The computer system of claim 1, further comprising an act of the retailer receiving the difference in price as reimbursement from the online vendor.

3. The computer system of claim 2, wherein the difference in price is received by the retailer's electronic payment system.

4. The computer system of claim 1, wherein the retailer provides an electronic payment system for receiving payments from mobile wallet applications.

5. The computer system of claim 1, wherein the user scans the product's bar code to search for the lowest price for the item online.

6. The computer system of claim 5, wherein bar code scanning and internet price searching are provided by the user's mobile wallet application.

7. The computer system of claim 1, wherein online vendor's prices are automatically applied by the mobile wallet at checkout for those retailers that price match.

8. The computer system of claim 1, wherein the mobile wallet is an application running on a mobile telephone.

9. The computer system of claim 1, wherein the mobile wallet is an application running on a prepaid mobile telephone.

10. The computer system of claim 1, wherein the user receives retailer- or producer-sponsored loyalty rewards that are stored in a brand locker associated with the user's mobile wallet account.

11. The computer system of claim 1, wherein the indication is received from a client application running on a mobile device that belongs to the user.

12. The computer system of claim 11, wherein the indication is received from the user's mobile wallet.

13. A computer system comprising the following:
one or more processors;
system memory;
one or more computer-readable storage media having stored thereon computer-executable instructions that, when executed by the one or more processors, causes the computing system to perform a method for providing a retailer with the lowest online price for price matching, the method comprising the following:
an act of receiving an indication that a bar code has been scanned for a specified product;
an act of performing an online search for the product associated with the bar code, the online search being configured to provide pricing information for the product and it's corresponding online vendors;
an act of determining, from the results of the online search, the lowest price for the product;
an act of determining, from the results of the online search, which online vendor provides the product at the determined lowest price; and
an act of communicating the lowest determined price and corresponding online vendor information to the retailer for price matching the indicated product.

14. The computer system of claim 13, wherein determining the lowest price for the product includes determining the cost of shipping the product in addition to the cost of the product.

15. The computer system of claim 13, wherein the indication that a bar code has been scanned for a specified product is received from a mobile wallet application running on a mobile device belonging to the user.

16. The computer system of claim 15, wherein the bar code is scanned using the mobile wallet application.

17. A computer system comprising the following:
one or more processors;
system memory;
one or more computer-readable storage media having stored thereon computer-executable instructions that, when executed by the one or more processors, causes the computing system to perform a method for receiving reimbursement from a product vendor for a price-matched item, the method comprising the following:
an act of receiving from a user an indication that a product sold by a retailer is to be purchased for a price indicated by an online vendor, the user having a mobile wallet with one or more linked payment accounts;
an act of determining that the price indicated by the online vendor is valid for the product;
an act of debiting at least one of the payment accounts linked to the user's mobile wallet for the price indicated by the online vendor; and
an act of debiting the difference in price between the retailer's price and the online vendor's price from a coupon account established between the retailer and the producer of the product.

18. The computer system of claim 17, wherein the coupon account includes money that is paid out to retailers as reimbursement for offering reduced coupon prices to the user.

19. The computer system of claim 17, wherein the producer of the product directly reimburses the retailer, even if the price discount is provided by a non-participating entity.

20. The computer system of claim 17, wherein the retailer is reimbursed by both the online vendor for at least part of the difference in price and by the product producer for at least part of the difference in price.
